(19) United States
(12) Patent Application Publication
(10) Pub. No.: US 2018/0263359 A1
(43) Pub. Date: Sep. 20, 2018

(54) Rotary Discharge Type Dye Container

(71) Applicant: YONWOO CO., LTD., Incheon (KR)

(72) Inventors: Sung-Hwan Kim, Incheon (KR); Sung-Sin Kim, Incheon (KR)

(21) Appl. No.: 15/539,937

(22) PCT Filed: Oct. 15, 2015
(86) PCT No.: PCT/KR2015/010900

§ 371 Date: Jun. 26, 2017

(30) Foreign Application Priority Data
Dec. 31, 2014 (KR) 10-2014-0194850

(51) Int. Cl. A45D 34/04; B05B 11/00

(52) U.S. Cl. CPC A45D 34/04; B05B 11/3053; A45D 2200/055; B05B 11/3023; B05B 11/3084

(57) ABSTRACT

A rotary discharge type dye container configured such that according to the rise and fall of a pump guiding member during rotation of a rotation body, pumping operations of first and second pumping members are performed and a hair dye and an oxidizing agent are discharged, thereby enabling high viscosity contents to be discharged and used even with little force.

### BACKGROUND

The present disclosure relates to a rotary discharge type dye container characterized by being configured such that according to the rise and fall of a pump guiding member during rotation of a rotation body, pumping operations of first and second pumping members are performed and a hair dye and an oxidizing agent are discharged, thereby enabling high viscosity contents to be discharged and used even with little force.

Generally, among contents packed in the containers, some make a synergy effect if they are mixed together when used. However, others would not be discharged properly due to precipitation or coagulation caused by physical or chemical reaction between contents mixed, or would have discoloration or spoil when they are received in the same container at first. Therefore, two contents to be mixed should be stored in separate containers, and then mixed when they are being used.

For example, for dyeing hair, a first liquid, a hair dye and a second liquid, an oxidizing agent, are supposed to be mixed together before being used. In case these hair dye and oxidizing agent are stored in a state of being mixed, spoiling will occur. Therefore, a hair dye and an oxidizing agent are mixed in a separate container after being stored in a separate container respectively.

However, these hair dye and oxidizing agent as in the above should be stored in separate containers and then mixed in another separate container when in use, which will lead to user's inconvenience due to complicate mixing process.

To solve these problems, recently, there have been introduced dye containers wherein hair dyes and oxidizing agents are stored separately inside a container body and then discharged separately or at the same time according to pumping operations by manipulation of a button part.

Contents like hair dyes and oxidizing agents are usually made into high viscosity solutions. In case contents have high viscosity, however, a user should press the button part rather hard to discharge the high viscosity contents, thereby leading to user inconvenience.

### SUMMARY OF THE DISCLOSURE

The presently described embodiments are devised to provide a rotary discharge type dye container characterized by being configured such that according to the rise/fall of a pump guiding member during rotation of a rotation body, pumping operations of first and second pumping members are performed and a hair dye and an oxidizing agent are discharged, thereby enabling high viscosity contents to be discharged and used even with little force.

To solve the problems in the above, a rotary discharge type dye container according to the present disclosure is characterized to include: first and second containers, disposed side by side with a hair dye and an oxidizing agent stored respectively and getting decreased in volume as the hair dye and the oxidizing agent are being used; first and second pumping members, coupled respectively to upper portions of the first and the second containers and discharging contents stored in the first and the second containers through pumping operations; a pump fixing body, coupled and encasing the first and second containers and fixing the first and the second pumping members to the first and the second containers; a rotation body, roatably coupled to the pump fixing body and provided with a rotation guide which forms a slope along an inner circumferential surface thereof; a pump guiding member, coupled to upper portions of the first and the second pumping members, and guiding pumping operations of the first and the second pumping members as rising/falling by rotation of the rotation body and simultaneously discharging the hair dye and the oxidizing agent stored in the first and the second containers,

characterized in that a vertical guide groove is provided at the pump fixing body for guiding a vertical movement of the pump guiding member, and at an outer circumferential surface of the pump guiding member is provided a guide protrusion which moves along a bottom surface of the rotation guide in a state of being inserted to the vertical guide groove and rising/falling inside the vertical guide groove.

Furthermore, it is characterized in that the pump guiding member further includes first and second movement tubes which are coupled to upper portions of the first and the second pumping members respectively and move a hair dye and an oxidizing agent discharged from the first and the second pumping members to upper portions thereof, and first and second discharge tubes which are connected to the first and the second movement tubes respectively and discharge the hair dye and the oxidizing agent to the outside through the first and the second movement tubes.

Furthermore, it is characterized in that a limitation protrusion is provided at both slope ends of the rotation guide for limiting the rotation of the guide protrusion, and a fixing protrusion is provided at a top dead center of a slope for fixing the guide protrusion in a state of the guide protrusion rising.

Furthermore, it is characterized in that a mixing part, coupled to an upper portion of the rotation body, further comprises first and second discharge holes such that a hair dye and an oxidizing agent are discharged respectively, and a center part sunken for a space where the hair dye and the oxidizing agent discharged through the first and second discharge holes be mixed.

Furthermore, it is characterized in that at the mixing part is provided first and second guide tubes which are inserted to an inner side of the first and second discharge tubes and guide a hair dye and an oxidizing agent moving to an upper portion through the first and the second discharge tubes to move to the first and the second discharge holes.

Furthermore, it is characterized in that at the mixing part are provided first and second nozzle tips which open/close the first and the second discharge holes according to pumping operations of the first and the second pumping members.

As described in the above, as the pump guiding member rises/falls when the rotation body rotates, pumping operations of the first and the second pumping members are performed, and a hair dye and a oxidizing agent are discharged, such that it is possible to discharge high viscosity contents with little force.

In addition, it is possible that a mixing part is formed at the rotation body with a center part sunken, such that a user can mix a hair dye and an oxidizing agent in the mixing part and discharge them for using them.

### BRIEF DESCRIPTION OF THE DRAWINGS

FIG. 1 is an exploded perspective view illustrating a configuration of a rotary discharge type dye container according to an exemplary embodiment.

FIG. 2 is an assembled perspective view illustrating a configuration of a rotary discharge type dye container according to an exemplary embodiment.

FIG. 3 is an assembled cross-sectional view illustrating a configuration of a rotary discharge type dye container according to an exemplary embodiment.

FIGS. 4 and 5 are explanatory views illustrating a using method of a rotary discharge type dye container according to an exemplary embodiment.

FIG. 6 is an assembled cross-sectional view illustrating a configuration of a rotary discharge type dye container according to another exemplary embodiment.

### DETAILED DESCRIPTION

Hereinafter, exemplary embodiments will be described in detail with reference to the accompanying drawings. The same reference numerals provided in the drawings indicate the same members.

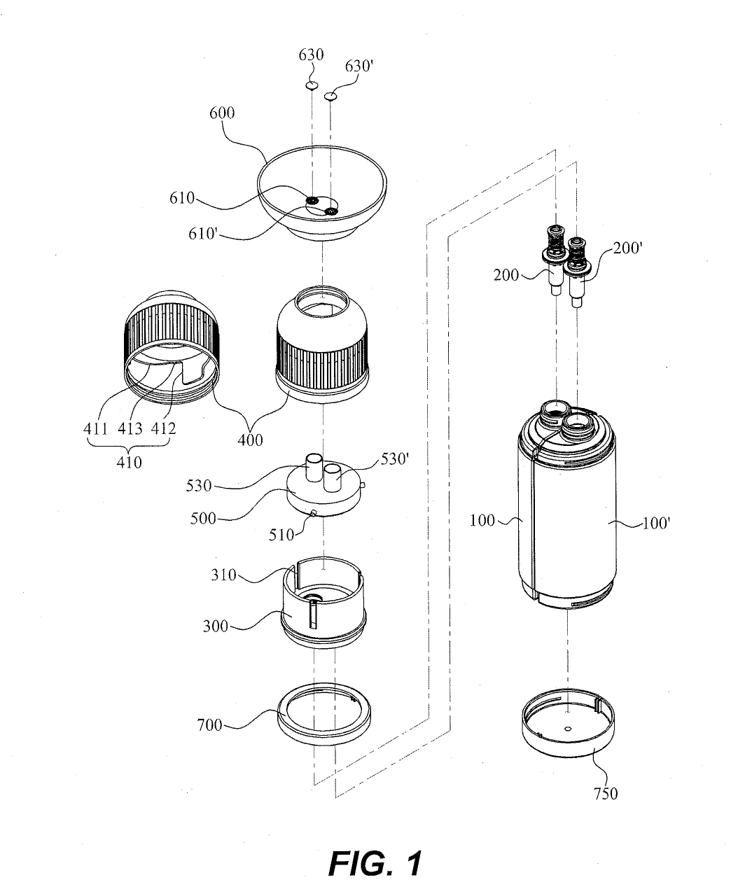

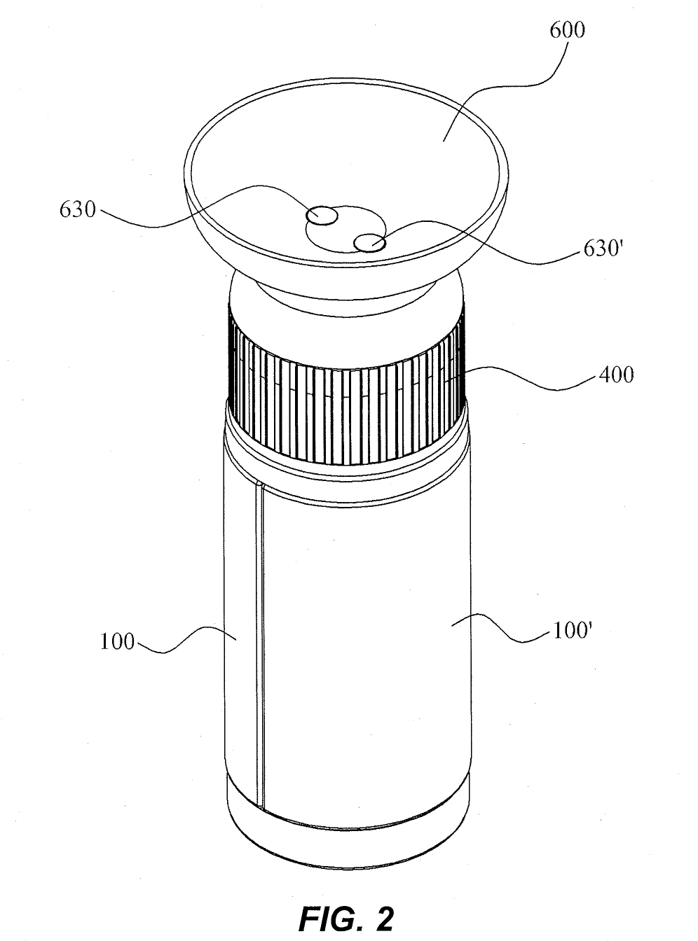

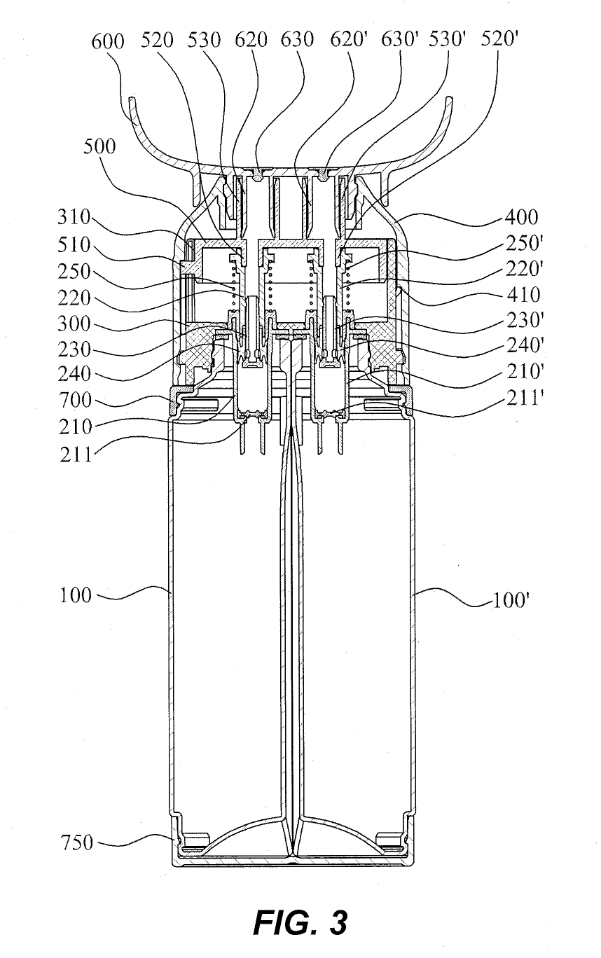

FIG. 1 is an exploded perspective view illustrating a configuration of a rotary discharge type dye container according to an exemplary embodiment. FIG. 2 is an assembled perspective view illustrating a configuration of a rotary discharge type dye container according to an exemplary embodiment. FIG. 3 is an assembled cross-sectional view illustrating a configuration of a rotary discharge type dye container according to an exemplary embodiment.

Referring to FIGS. 1 to 3, a rotary discharge type dye container according to an exemplary embodiment includes first and second containers 100, 100′, first and second pumping members 200, 200′, a pump fixing body 300, a rotation body 400, and a pump guiding member 500.

The first and second containers 100, 100′, where a hair dye and an oxidizing agent are stored, are configured to be disposed side by side in a state of storing a hair dye and an oxidizing agent. It is also possible that the first and second containers 100, 100′ are configured to be composed of various containers whose volume decreases as contents are being used, such as a blow container compressed as being used, or a dispenser container equipped with a piston which rises according to the use of content

Meanwhile, it is preferred that a first support body 700 and the second support body 750 are respectively provided at an upper portion and a lower portion of the first and the second containers 100, 100′ for supporting the upper portion and the lower portion of the first and the second containers 100, 100′respectively.

The first and the second pumping members 200, 200′ are composed of first and second cylinders 210, 210′ which are respectively coupled at upper portions of the first and the second containers 100, 100′ and discharge simultaneously a hair dye and an oxidizing agent stored in the first and the second containers 100, 100′, further provided with first and second check valves 211, 211′ at an inner lower end thereof; first and second stems 220, 220′, one side of which is coupled to a pump guiding member 500 to be described later, and the other of which is disposed at an inner side of the first and the second cylinders 210, 210′, and move along together according to the upward/downward movement of the pump guiding member 500; first and second piston rods 230, 230′ coupled to a lower portions of the first and second stems 220, 220′; first and second seal caps 240, 240′, coupled as encasing an outer circumferential surface of the first and the second piston rods 230, 230′ at a lower portions of the first and the second stems 220, 220′; and first and second spring 250, 250′ coupled as encasing the circumference of the first and the second stems 220, 220′ and providing elastic force in the upward direction such that the pump guiding member 500 can repeatedly pumps.

The pump fixing body 300, which is coupled as encasing upper portions of the first and the second container bodies 100, 100′ and fixes the first and the second pumping members 200, 200′ to the first and the second container bodies 100, 100′,

is characterized in that a vertical guide groove 310, is laterally formed such that a guide protrusion 510 to be described later can be inserted at an outer circumferential surface of the pump fixing body 300 and guides the vertical movement of the pump guiding member 500, wherein the vertical guide groove 310 is preferred to have three thereof formed with fixed distance apart in about 120 degrees for a stable operation, as illustrated in FIG. 1.

Though it is illustrated that three of the vertical guide grooves 310 are formed with a fixed distance apart in about 120 degrees, various exemplary embodiments such as having simply two formed at both sides are possible.

The rotation body 400, detachably coupled to the pump fixing body 300 and raising/lowering the pump guiding member 500 according to rotation thereof, is characterized in that a rotation guide 410 forming a slope along an inner circumferential surface is provided at an inner side of the rotation body 400.

At a lower surface of the rotation guide 410 is disposed a guide protrusion 510 to be described later, wherein the lower surface of the rotation guide 410 pressurizes the guide protrusion 510 when the rotation body 400 rotates, and then the guide protrusion 510 is moved by a shape of the rotation guide 410 which forms a slope 411, thereby leading the pump guiding member 500 to rise/fall.

A limitation protrusion 412 is provided at both ends of the slope 411 of the rotation guide 410 for limiting the rotation of the guide protrusion 510, and a fixing protrusion 413 is provided at a top dead center of the slope 411 for fixing the guide protrusion 510 in a state of the guide protrusion 510 rising.

Meanwhile, it is characterized in that at an upper portion of the rotation body 400 is coupled a mixing part 600 which has a center part sunken for forming a space where a hair dye and an oxidizing agent are mixed, provided with first and second discharge hole 610, 610′ at the mixing part 600 such that the hair dye and the oxidizing agent can be discharged respectively, and further equipped with first and second nozzle tips 630, 630′ which open/closes the first and the second discharge holes 610, 610′ according to pumping operations of the first and the second pumping members 200, 200′.

Furthermore, at the missing part 600 are provided first and second guide plates 620, 620′ which are inserted to an inner side of the first and the second discharge tubes 530, 530′ and guide the hair dye and the oxidizing agent to move to the first and the second discharge holes 610, 610′ through the first and the second discharge tubes 530, 530′. A lower portion of the first and the second guide plates 620, 620′ are preferred to have a piston shape which is closely contacted to an inner wall of the first and the second discharge tubes 530, 530′ for preventing contents from moving to an outer wall of the first and the second guide tubes 620, 620′ and to an inner wall of the first and the second discharge tubes 530, 530′.

The pump guiding member 500, coupled to an upper portion of the first and the second pumping members 200, 200′ and inducing pumping operations of the first and the second pumping members 200, 200′ as rising/falling by rotation of the rotation body 400, thereby simultaneously discharging the hair dye and the oxidizing agent stored in the first and the second containers 100, 100′. At an outer circumferential surface of the first and the second pump guiding members 500 are provided a guide protrusion 510 which moves along a lower surface of the rotation guide 410 and rises/falls inside the vertical guide groove 310 in a state of being inserted to the vertical guide groove 310.

The guide protrusion 510, configured to move along a bottom surface of the rotation guide 410, moves upwards and downward by the shape of the rotation guide when the rotation body 400 rotates, which induces pumping operations of the first and the second pumping member 200, 200′ as the pump guiding member 500 rises/falls.

Furthermore, the pump guiding member 500 is configured to be coupled to upper portions of the first and the second pumping members 200, 200′ respectively and thereby to move the hair dye and the oxidizing agent discharged from the first and the second pumping member 200, 200′ to the mixing part 600. For this, the pump guiding member 500 is composed of first and second movement tubes 520, 520′ which are coupled to the first and the second stems 220, 220′ and form a space where the contents discharged through the first and the second stems 220, 220′ can move to an upper portion thereof; and first and second discharge tubes 530, 530′ which are respectively connected to the first and the second movement tubes 520, 520′ and move the hair dye and the oxidizing agent moving through the first and the second movement tubes 520, 520′ to the first and the second discharge holes 610, 610′ of the mixing part 600.

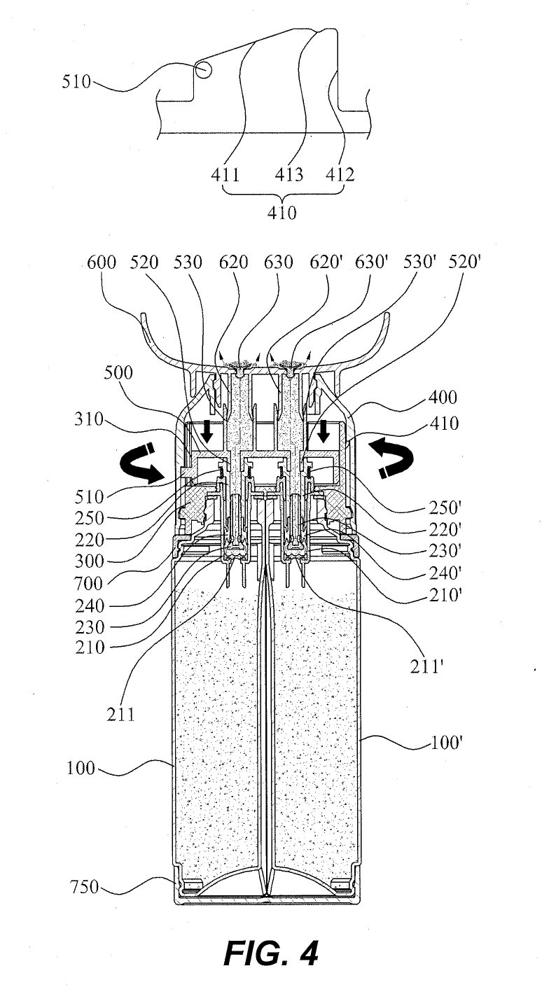

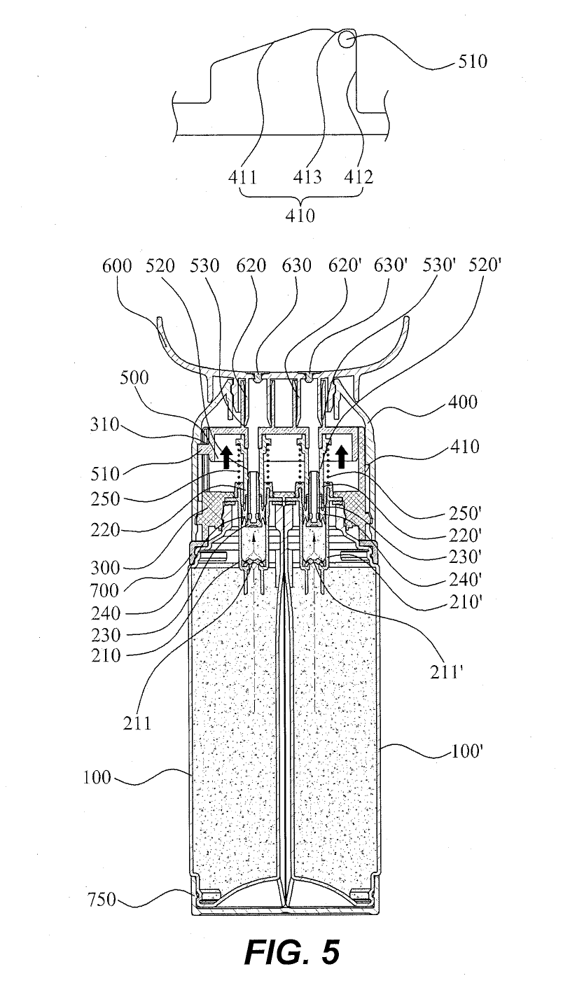

Hereafter, referring to FIGS. 4 and 5, a using method of a rotary discharge type dye container according to an exemplary embodiment will be described. FIGS. 4 and 5 are explanatory views illustrating a using method of a rotary discharge type dye container according to an exemplary embodiment. FIGS. 4 and 5 are explanatory views illustrating a using method of a rotary discharge type dye container according to an exemplary embodiment.

Referring to FIGS. 4 and 5, when the rotation body 400 is rotated in a process of the first and the second containers 100, 100′ being pressed, the guide protrusion 510 of the pump guiding member 500 is pressurized by the bottom surface of the rotation guide 410 of the rotation body 400 and rises/falls. At this time, the guide protrusion is guided to vertically move by a vertical guide groove 310 of the pump fixing body 300.

As in the above, when the guide protrusion 510 is vertically moved, the pump guiding member 500 rises/falls, such that the first and the second pumping members 200, 200′ perform pumping operations. Due to this, the hair dye and the oxidizing agent respectively stored in the first and the second containers 100, 100′ flow into the first and the second cylinders 210, 210′, and the hair dye and the oxidizing agent flowing into the first and the second cylinders 210, 210′ go through the first and the second movement tubes 520, 520′ and the first and the second discharge tubes 530, 530′ and are discharged to an upper end of the mixing part 600 through the first and the second discharge holes 610, 610′.

When the hair dye and the oxidizing agent are discharged to an upper end of the mixing part 600, as in the above, a user can use the hair dye and the oxidizing agent by directly mixing them inside the mixing part 600.

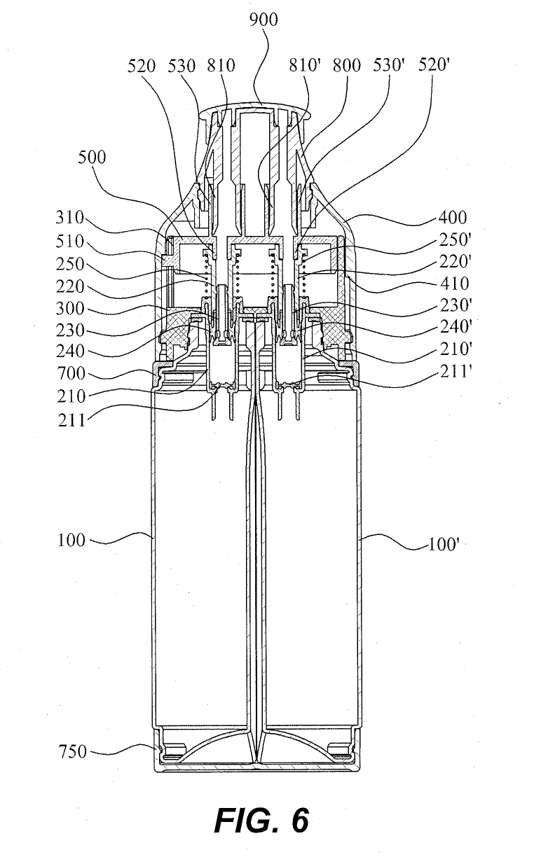

Hereafter, referring FIG. 6, a rotary discharge type dye container according to another exemplary embodiment will be explained. FIG. 6 is a cross-sectional view illustrating a configuration of a rotary discharge type dye container according to another exemplary embodiment.

Referring FIG. 6, a rotary discharge type dye container according to another exemplary embodiment does not include a mixing part 600 at an upper portion of the rotation body 400, but is coupled with a nozzle part 800 which discharges a hair dye and an oxidizing agent, wherein the hair dye and the oxidizing agent are discharged to a separate mixing container through first and second nozzle tubes 810, 810′ of the nozzle part 800, and then are mixed for use.

Meanwhile, an over cap 900 which opens/closes is detachably coupled to the nozzle part 900.

As described in the above, since the other elements are the same in structures and functions thereof as in exemplary embodiments, detailed description will be omitted.

As described above, optimal embodiments have been disclosed in the drawings and the specification. Although specific terms have been used herein, these are not intended to limit the meanings of the terms or to restrict the scope of the contemplated embodiments as recited in the accompanying claims. Therefore, those skilled in the art will appreciate that various modifications and other equivalent embodiments are possible from the above embodiments.

1. An rotary discharge type dye container, comprising:
first and second containers, disposed side by side with a hair dye and an oxidizing agent stored respectively and getting decreased in volume as the hair dye and the oxidizing agent are being used;
first and second pumping members, coupled respectively to upper portions of the first and the second containers and discharging contents stored in the first and the second containers through pumping operations;
a pump fixing body, coupled and encasing the first and second containers and fixing the first and the second pumping members to the first and the second containers;
a rotation body, roatably coupled to the pump fixing body (300) and provided with a rotation guide which forms a slope along an inner circumferential surface thereof;
a pump guiding member, coupled to upper portions of the first and the second pumping members and guiding pumping operations of the first and the second pumping members as rising/falling by rotation of the rotation body and simultaneously discharging the hair dye and the oxidizing agent stored in the first and the second containers, further comprising first and second movement tubes moving a hair dye and an oxidizing agent discharged from the first and the second pumping members to upper portions thereof, and first and second discharge tubes connected to the first and the second movement tubes respectively and discharging the hair dye and the oxidizing agent to the outside through the first and the second movement tubes, and
a mixing part, coupled to an upper portion of the rotation body, further comprises first and second discharge holes such that a hair dye and an oxidizing agent are discharged respectively, and a center part sunken for a space where the hair dye and the oxidizing agent discharged through the first and second discharge holes be mixed,
wherein a vertical guide groove is provided at the pump fixing body for guiding a vertical movement of the pump guiding member, and at an outer circumferential surface of the pump guiding member is provided a guide protrusion which moves along a bottom surface of the rotation guide in a state of being inserted to the vertical guide groove and rising/falling inside the vertical guide groove.

2. The rotary discharge type dye container of claim 1, wherein a limitation protrusion is provided at both slope ends of the rotation guide for limiting the rotation of the guide protrusion, and a fixing protrusion is provided at a top dead center of a slope for fixing the guide protrusion in a state of the guide protrusion rising.

3. The rotary discharge type dye container of claim 1, wherein at the mixing part are provided first and second nozzle tips which open/close the first and the second discharge holes according to pumping operations of the first and the second pumping members.
